(19) United States
(12) Patent Application Publication
(10) Pub. No.: US 2011/0203117 A1
(43) Pub. Date: Aug. 25, 2011

(54) GARDEN SHEAR CUTTING HEAD WITH A LUBRICATED PIVOT

(75) Inventor: Yao-Chung Huang, Fu Shing Hsiang (TW)

(73) Assignee: HO CHENG GARDEN TOOLS CO., LTD., FU SHING HSIANG (TW)

(21) Appl. No.: 12/712,193

(22) Filed: Feb. 25, 2010

(51) Int. Cl. A01G 3/025

(52) U.S. Cl. 30/254; 30/267

(57) ABSTRACT

A garden shear cutting head with a lubricated pivot has: a shear body and a pivot. The shear body has a first cutting member and a second cutting member. A circular first assembling aperture is disposed in the first cutting member, and one end of the first assembling aperture has a lubrication slot. The second cutting member has a non-circular second assembling aperture corresponding to the first assembling aperture of the first cutting member, and a concave lip is around the second assembling aperture positioned to correspond to the lubrication slot. The pivot comprises a screw and a washer and is disposed through the first assembling aperture and the second assembling aperture and engaged with a locking member at another end. The screw has a head end, the head end has a filling hole through a central portion.

### BACKGROUND OF THE INVENTION

1. Field of the Invention

The present invention relates to a garden shear cutting head with a lubricated pivot, and more particularly to a garden shear cutting head with a lubricated pivot having an oil channel.

2. Description of the Related Art

Currently, a prior art garden shear structure, as shown in FIG. 7, comprises a shear body 30 and a bolt 40. The shear body 30 comprises first and second cutting members 31, 32 that overlap each other and two handles 311, 321 at respective ends of the first and second cutting members 31, 32. A circular first through aperture 312 is disposed on the first cutting member 31, and a rectangular second through aperture 322 is disposed on the second cutting member 32 at a position corresponding to the first through aperture 312 of the first cutting member 31. The bolt 40 is placed through the first and second through apertures 312, 322 of the first and second cutting members 31, 32, and a washer 41 is incorporated with the bolt 40 to reduce friction between the shear body 30 and the bolt 40. The bolt 40 has a circular columnar section 42 corresponding to the through aperture 312 of the first cutting member 31 and rotates freely in relation to the first cutting member 31. The bolt 40 further has an engaging section 43 corresponding to the through aperture 322 of the second cutting member 32 and is able to rotate with the second cutting member 32. An end of the bolt 40 has a threaded portion 44 that is locked with a nut 45. The bolt 40 has an axial oil chamber 46, and a radial channel 47 is disposed on the bolt 40 and connected to the oil chamber 46.

With the above-mentioned structure, the oil chamber 46 can be filled with lubrication oil, which flows into the channel 47, and thus the lubrication oil further enters between the first and second cutting members 31, 32 of the shear body 30.

However, the prior art structure has the following drawbacks:

1. The respective surfaces of the first cutting member 31 and the second cutting member 32 of the shear body 30 are tightly engaged with each other and so little or no lubrication oil is able to penetrate between the surfaces.

2. With respect to the bolt 40, only the channel 47 is connected to the oil chamber 46 to cause lubrication oil to flow between the first and second cutting members 31, 32. No path is provided for the lubrication oil to enter between the washer 41 and the bolt 40, and so the friction between the washer 41 and the bolt 40 may create usage difficulties.

Therefore, it is desirable to provide a garden shear cutting head with a lubricated pivot to mitigate and/or obviate the aforementioned problems.

### SUMMARY OF THE INVENTION

An objective of the present invention is to provide an improved reflective structure.

In order to achieve the above-mentioned objectives, a garden shear cutting head with a lubricated pivot comprises: a shear body and a pivot. The shear body comprises a first cutting member and a second cutting member. A circular first assembling aperture is disposed in the first cutting member, and one end of the first assembling aperture has a lubrication slot. The second cutting member has a non-circular second assembling aperture corresponding to the first assembling aperture of the first cutting member, and a concave lip is around the second assembling aperture positioned to correspond to the lubrication slot. The pivot comprises a screw and a washer and is disposed through the first assembling aperture and the second assembling aperture and engaged with a locking member at another end. The screw has a head end, the head end has a filling hole through a central portion, and a bottom face of the head end corresponds to a top surface of the washer. The head end has an extension section with a columnar shape, and an oil channel spiraling around an outer surface of the extension section. A center section at a lower portion of the screw has two engaging sections on two opposite sides corresponding to the second assembling aperture of the second cutting member, and a through aperture is disposed between the two engaging sections and connected to the filling hole. A threaded section extends below the engaging section, the washer has an extending neck corresponding to the first assembling aperture of the first cutting member, and the washer has a through hole corresponding to the extension section of the screw. An upper end of the through hole has an inclined surface corresponding to the head end of the screw.

The first cutting member and the second cutting member of shear body are locked together by the pivot provided by aligning the first assembling aperture with the second assembling aperture. The lubrication slot of the first cutting member and the concave lip of the second cutting member face each other to form a groove between the combined first cutting member and the second cutting member. The neck extension of the washer is disposed in the first assembling aperture of the first cutting member, and the screw is inserted into the through hole of the washer such that the bottom face of the head end presses onto the inclined surface of the washer. The engaging section of the screw protrudes from the neck extension and engages with the second assembling aperture of the second cutting member, and the through aperture on the engaging section is disposed between the lubrication slot and the concave lip of the first and second cutting members. Consequently, the first cutting member of the shear body is capable of being freely rotated around the neck extension of the washer, and the second cutting member is capable of simultaneously rotating with the screw. Additionally, the threaded section of the screw protrudes from the second cutting member and is locked with the locking member.

With the above-mentioned structure the following benefits are realized: 1. The shear body has the lubrication slot and the concave lip on the first assembling aperture and the second assembling aperture of the first and second cutting members, and therefore the lubrication oil filling the filling hole of the screw flows into the lubrication slot and the concave lip between the first and second cutting members to fully lubricate the shear body. 2. The extension section of the screw has the oil channel spiraling around its outer surface, and so the lubrication oil can move along the oil channel to reach between the extension section of the screw and the through hole of the washer.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is a perspective exploded view of an embodiment of the present invention.

FIG. 3 is a cross-sectional view of an embodiment of the present invention.

FIG. 4 is another cross-sectional view of an embodiment of the present invention.

FIG. 5 illustrates usage of an embodiment of the present invention.

FIG. 6 is another diagram illustrating usage of an embodiment of the present invention.

FIG. 7 is an exploded view of a prior art structure.

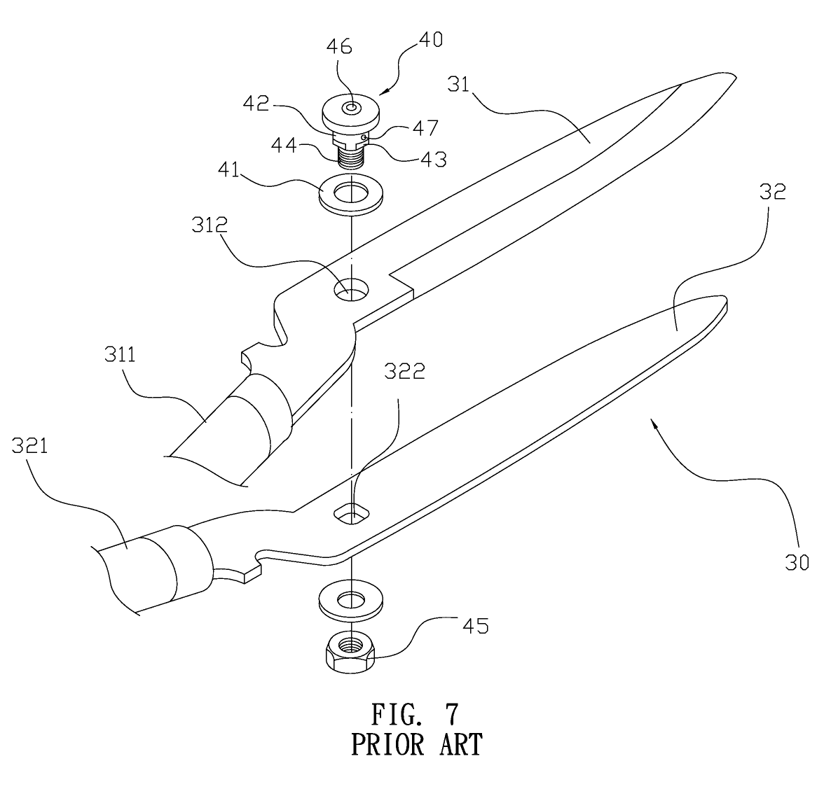

### DETAILED DESCRIPTION OF THE PREFERRED EMBODIMENT

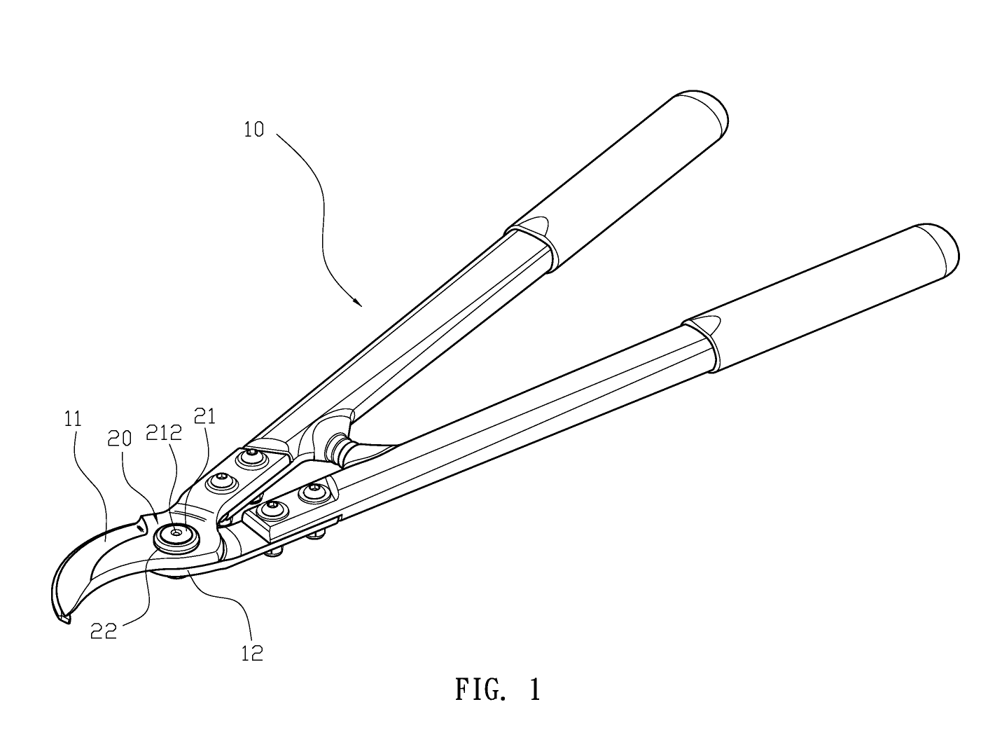

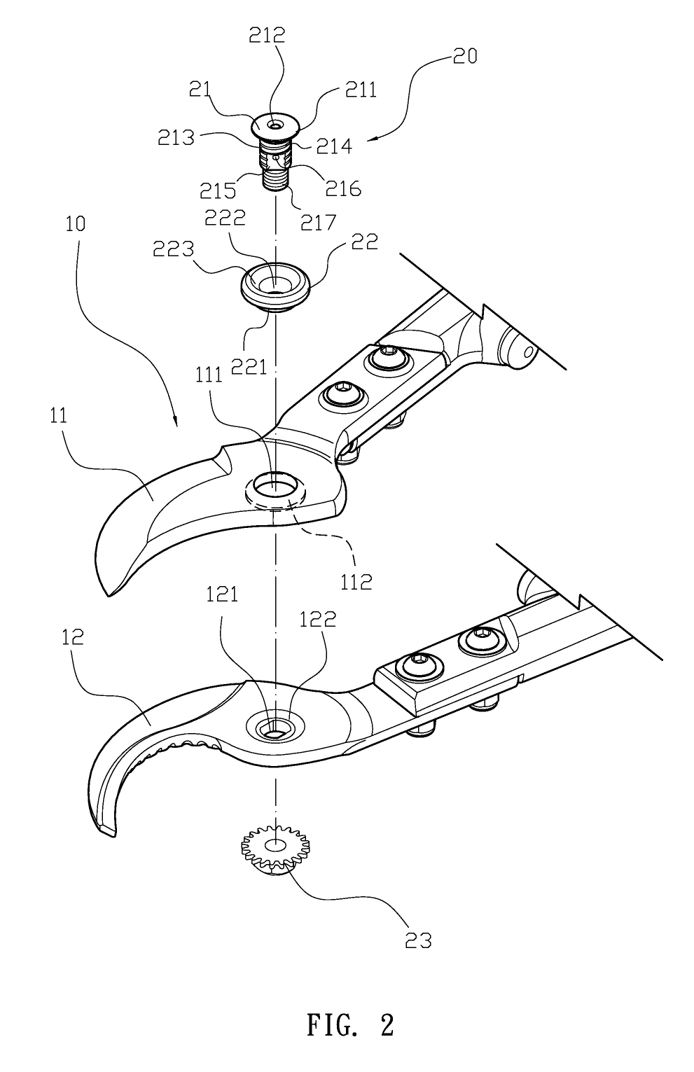

Please refer to FIG. 1 and FIG. 2. A garden shear cutting head with a lubricated pivot comprises a shear body 10 and a pivot 20. The shear body 10 comprises a first cutting member 11 and a second cutting member 12; a circular first assembling aperture 111 is disposed in the first cutting member 11, and one end of the first assembling aperture 111 has a lubrication slot 112. The second cutting member 12 has a non-circular second assembling aperture 121 at a position corresponding to the first assembling aperture 111 of the first cutting member 11; a concave lip 122 around the second assembling aperture 121 is positioned to correspond to the lubrication slot 112.

The pivot 20 comprises a screw 21, and a washer 22 is disposed through the first assembling aperture 111 and the second assembling aperture 121 and engages with a locking member 23 at another end. The screw 21 has a head end 211, and the head end 211 has a filling hole 212 through a central portion thereof. A bottom face of the head end 211 corresponds to a top surface of the washer 22. The head end 211 further includes an extension section 213 with a columnar shape and an oil channel 214 spirals around an outer surface of the extension section 213. A central section at a lower portion of the screw 21 has two engaging sections 215 on two opposite sides that correspond to the second assembling aperture 121 of the second cutting member 12, and a through aperture 216 is disposed between the two engaging sections 215 and connects to the filling hole 212. A threaded section 217 extends below the engaging section 215. The washer 22 has an neck extension 221 corresponding to the first assembling aperture 111 of the first cutting member 11; the washer 22 further includes a through hole 222 corresponding to the extension section 213 of the screw 22. An upper end of the through hole 222 has an inclined surface 223 corresponding to the head end 211 of the screw 21.

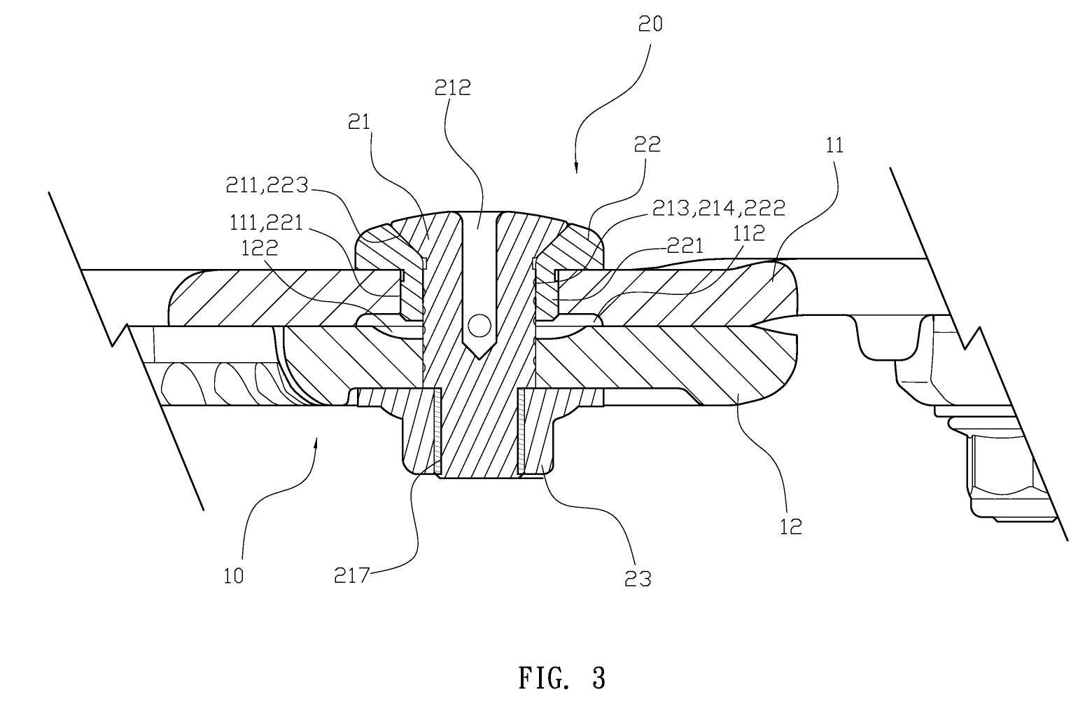

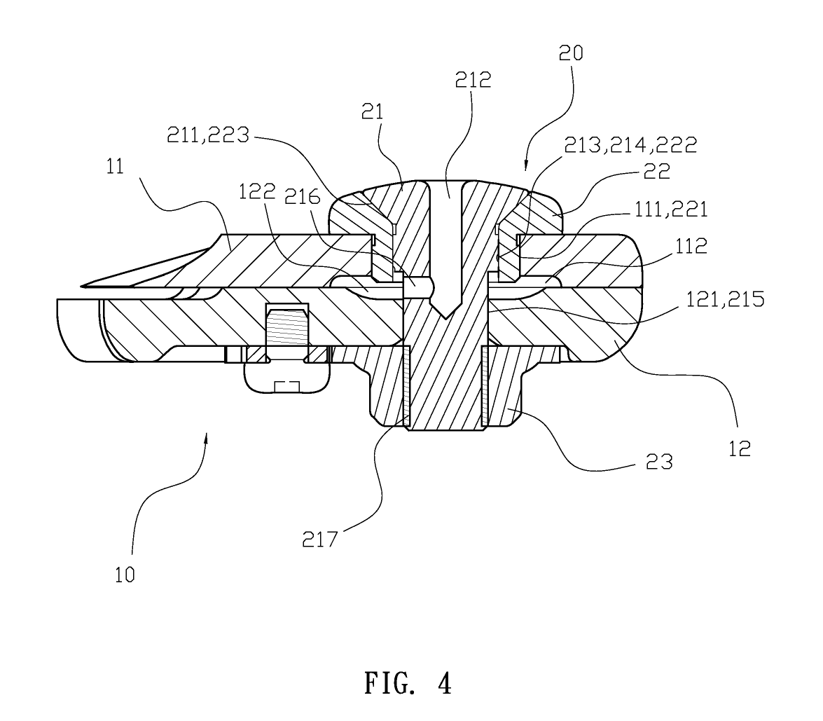

For a structural assembly, please refer to FIGS. 2, 3, and 4. The first cutting member 11 and the second cutting member 12 of shear body 10 are locked together by the pivot 20 provided by aligning the first assembling aperture 111 with the second assembling aperture 121. The lubrication slot 112 of the first cutting member 11 and the concave lip 122 of the second cutting member 12 face each other to form a groove between the combined first cutting member 11 and the second cutting member 12. The neck extension 221 of the washer 22 is disposed in the first assembling aperture 111 of the first cutting member 11, and the screw 21 is inserted into the through hole 222 of the washer 22 such that the bottom face of the head end 211 presses onto the inclined surface 223 of the washer 22. The engaging section 215 of the screw 21 protrudes from the neck extension 221 and engages with the second assembling aperture 121 of the second cutting member 12, and the through aperture 216 on the engaging section 215 is disposed between the lubrication slot 112 and the concave lip 122 of the first and second cutting members 11, 12. Consequently, the first cutting member 11 of the shear body 10 is capable of being freely rotated around the neck extension 221 of the washer 22, and the second cutting member 12 is capable of simultaneously rotating with the screw 21. Additionally, the threaded section 217 of the screw 21 protrudes from the second cutting member 12 and is locked with the locking member 23.

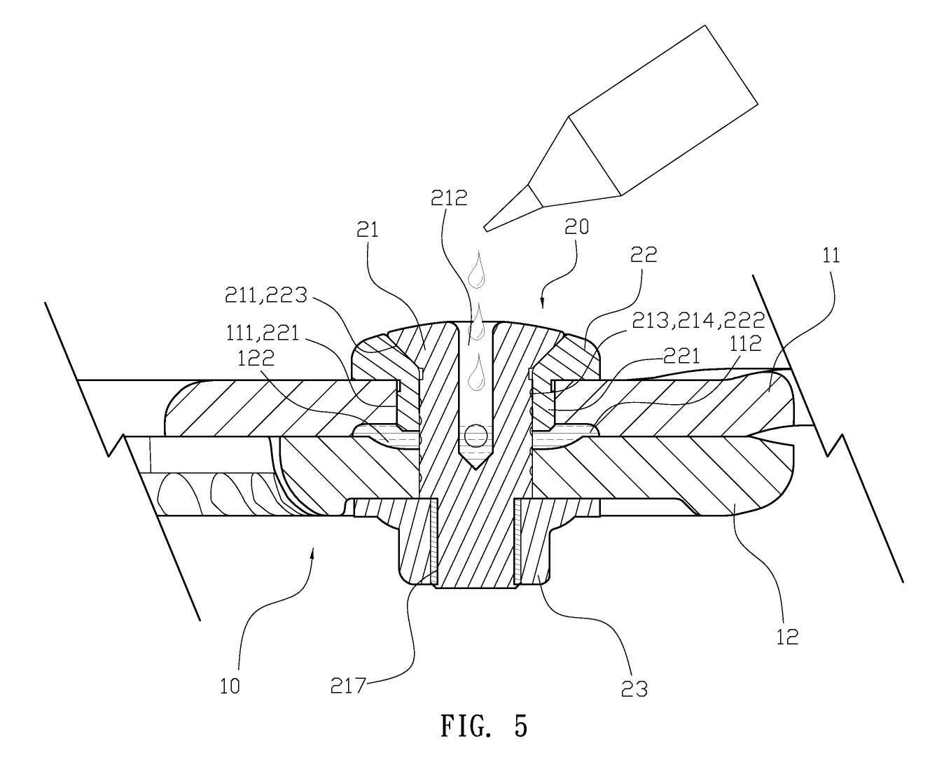

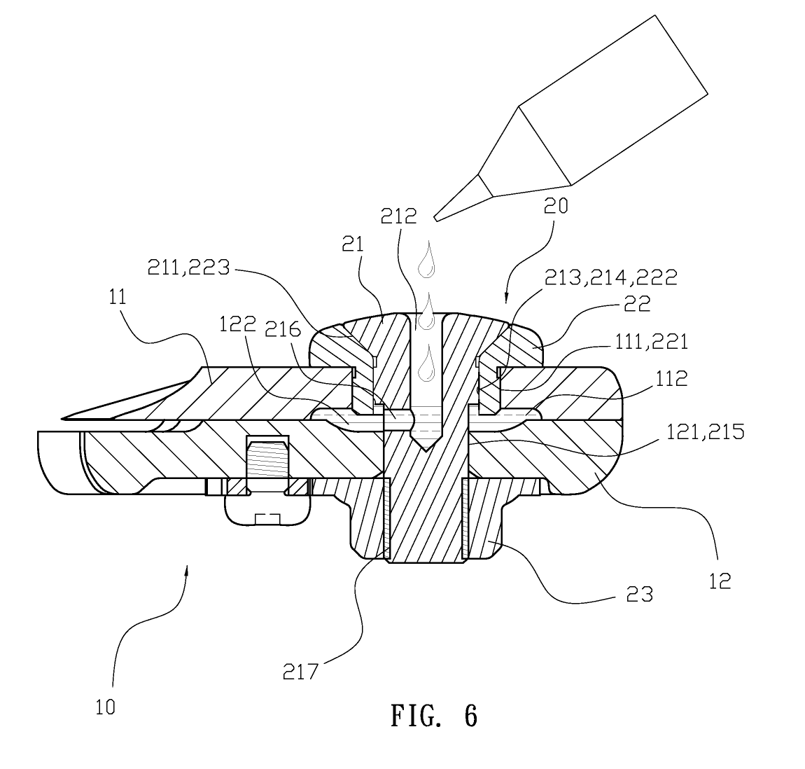

For actual operations please refer to FIGS. 5 and 6. The shear body 10 is well suited for garden shearing. The filling hole 212 of the screw 21 can be filled with lubrication oil, and the lubrication oil then moves from the filling hole 212 to the through aperture 21 of the engaging section 215 to lubricate between the lubrication slot 112 and the concave lip 122 of the first and second cutting members 11, 12, such that the shear body 10 is lubricated between opening and closing movements. The extension section 213 of the screw 21 has the oil channel 214 spiraling around its outer surface, and so the lubrication oil can move along the oil channel 214 to reach between the extension section 213 of the screw 21 and the through hole 222 of the washer 22. Therefore, the screw 21 and the washer 22 of the pivot 20 can also be lubricated by the lubrication oil. In addition, the head end 211 of the screw 21 is tightly engaged with the inclined surface 223 of the washer 22, and so the lubrication oil is limited to between the screw 21 and the washer 22 to prevent the lubrication oil from leaking from the through hole 222 of the washer 22.

With the above-mentioned structure the following benefits are realized: 1. The shear body 10 has the lubrication slot 112 and the concave lip 122 on the first assembling aperture 111 and the second assembling aperture 121 of the first and second cutting members 11, 12, and therefore the lubrication oil filling the filling hole 212 of the screw 21 flows into the lubrication slot 112 and the concave lip 122 between the first and second cutting members 11, 12 to fully lubricate the shear body 10. 2. The extension section 213 of the screw 21 has the oil channel 214 spiraling around its outer surface, and so the lubrication oil can move along the oil channel 214 to reach between the extension section 213 of the screw 21 and the through hole 222 of the washer 22.

Although the present invention has been explained in relation to its preferred embodiment, it is to be understood that many other possible modifications and variations can be made without departing from the spirit and scope of the invention as hereinafter claimed.

What is claimed is:

1. A garden shear cutting head with a lubricated pivot comprising: a shear body and an pivot, the shear body comprising a first cutting member and a second cutting member, a circular first assembling aperture disposed in the first cutting member, one end of the first assembling aperture having a lubrication slot; a non-circular second assembling aperture disposed on the second cutting member having corresponding to the first assembling aperture of the first cutting member, a concave lip around the second assembling aperture positioned to correspond to the lubrication slot;
a pivot comprising a screw and a washer disposed through the first assembling aperture and the second assembling aperture and engaged with a locking member at another end, the screw having a head end, the head end having a filling hole through a central portion, a bottom face of the head end corresponding to a top surface of the washer, the head end having an extension section with a columnar shape, and an oil channel spiraling around an outer surface of the extension section; a center section at a lower portion of the screw having two engaging sections on two opposite sides corresponding to the second assembling aperture of the second cutting member, and a through aperture disposed between the two engaging sections and connected to the filling hole; a threaded section extending below the engaging section, the washer having an extending neck corresponding to the first assembling aperture of the first cutting member, and the washer having a through hole corresponding to the extension section of the screw; and an upper end of the through hole having an inclined surface corresponding to the head end of the screw.
